(19) United States
(12) Patent Application Publication
(10) Pub. No.: US 2022/0071315 A1
(43) Pub. Date: Mar. 10, 2022

(54) SEAM STRUCTURE OF PROTECTIVE CLOTHING THAT IS CAPABLE OF BEING FORMED QUICKLY AND HAS HIGH SEALING PERFORMANCE

(71) Applicant: FUNG LEAD MEDICAL AND SPORTS CO., LTD., Nantou County (TW)

(72) Inventor: David WEN, Nantou County (TW)

(21) Appl. No.: 17/015,084

(22) Filed: Sep. 9, 2020

(51) Int. Cl. A41D 13/00; B29C 65/00; A41D 27/24

(52) U.S. Cl. CPC A41D 13/0002; A41D 27/24; B29C 66/1122

(57) ABSTRACT

A seam structure of protective clothing that is capable of being formed quickly and has high sealing performance provided includes: a first cloth including a first side surface and a second side surface opposite to each other; a second cloth welded to the first cloth and including a first surface and a second surface opposite to each other, wherein the first surface is abutted against and welded to the first side surface to form a first welding portion; a sealing cloth including a first sealing section and a third sealing section, wherein the first sealing section is abutted against and welded to the second side surface of the first cloth to form a second welding portion, and the third sealing section is abutted against and welded to the second surface of the second cloth to form a fourth welding portion.

### BACKGROUND

### Field of the Invention

The present invention relates to a protecting clothing, and more particularly to a seam structure of protective clothing that is capable of being formed quickly and has high sealing performance.

### Related Prior Art

In the general medical places, medical staff who come into contact with patients with infectious diseases need to wear protective clothing to avoid infection with the disease through droplets or contact. Therefore, the airtightness and isolation of protective clothing are very important.

The conventional protective clothing is woven and sewn by a plurality of cloths 90. Please refer to FIG. 1, two cloths 90 each includes a first surface 91 and a second surface 92 opposite to each other. The two cloths 90 are joined by weaving and sewing. At this time, the stitching 70 is against the first surfaces 91 of the two cloths 90. However, a seam 93 will be formed between the second surfaces 92 of the two cloths 90, thereby reducing the performance of sealing and isolation.

In order to overcome the aforementioned problems, the general method is to paste an adhesive tape 80 along the seam 93 between the two cloths 90 to seal the seam 93. However, such secondary processing cause waste of man-hours, labor-intensive, etc., and since the step of attaching the adhesive tape 80 is performed manually, the processing quality will be inconsistent. Therefore, a seam structure capable of rapid forming and high sealing is required.

The present invention has arisen to mitigate and/or obviate the afore-described disadvantages.

### SUMMARY

The present invention provides a seam structure of protective clothing that is capable of being formed quickly and has high sealing performance, the purpose of which is to make the edge seam structure fast forming and improve sealing performance.

To achieve the above objective, a seam structure of protective clothing that is capable of being formed quickly and has high sealing performance provided by the invention comprises:
a first cloth including a first side surface and a second side surface opposite to each other;
a second cloth welded to the first cloth and including a first surface and a second surface opposite to each other, wherein the first surface is abutted against and welded to the first side surface to form a first welding portion;
a sealing cloth including a first sealing section and a third sealing section, wherein the first sealing section is abutted against and welded to the second side surface of the first cloth to form a second welding portion, and the third sealing section is abutted against and welded to the second surface of the second cloth to form a fourth welding portion.

From the foregoing, it can be seen that the present invention mainly welds the first cloth, the second cloth and the sealing cloth to each other through technical means such as ultrasonic waves, so that the first welding portion is formed between the first cloth and the second cloth, the second welding portion is formed between the first sealing section of the sealing cloth and the second side surface, the fourth welding portion is formed between the third sealing section and the second surface, and the first welding portion, the second welding portion, and the fourth welding portion are formed simultaneously, so as to achieve the purpose of rapid forming.

In addition, the sealing cloth can close the gap between the first cloth and the second cloth to achieve the purpose of improving sealing performance.

Besides, in this invention, the first cloth , the second cloth and the sealing cloth are joined by welding technology. Therefore, there is no need to coat an additional layer of glue, which can avoid the problem of adhesion reduction after a long time.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

FIG. 1 is an illustrative view of the seam structure of the conventional protective clothing;

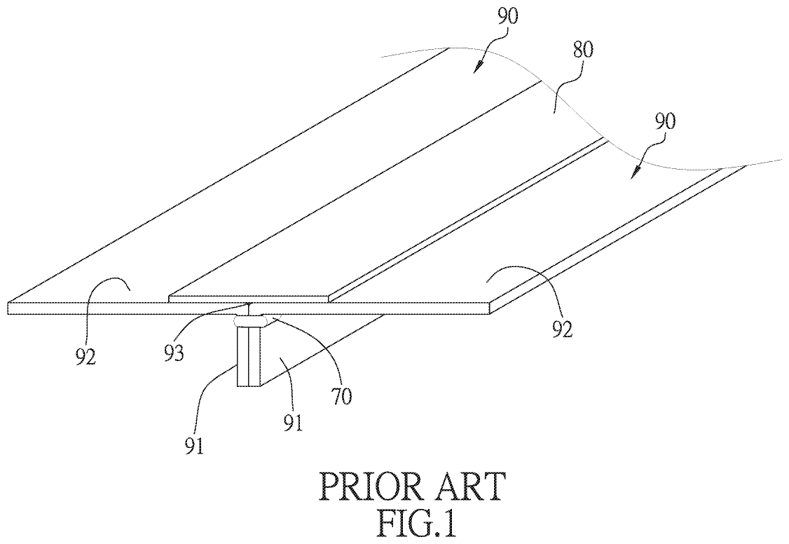

FIG. 2 is an illustrative view of the invention showing the seam structure of protective clothing that is capable of being formed quickly and has high sealing performance; and

FIG. 3 is an illustrative view of the invention showing the seam structure of protective clothing that is capable of being formed quickly and has high sealing performance.

### DETAILED DESCRIPTION

The present invention will be clearer from the following description when viewed together with the accompanying drawings, which show, for purpose of illustrations only, the preferred embodiment in accordance with the present invention.

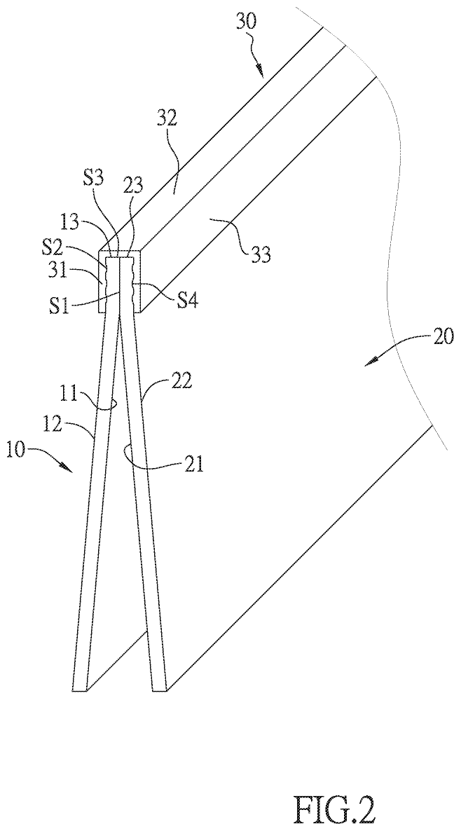

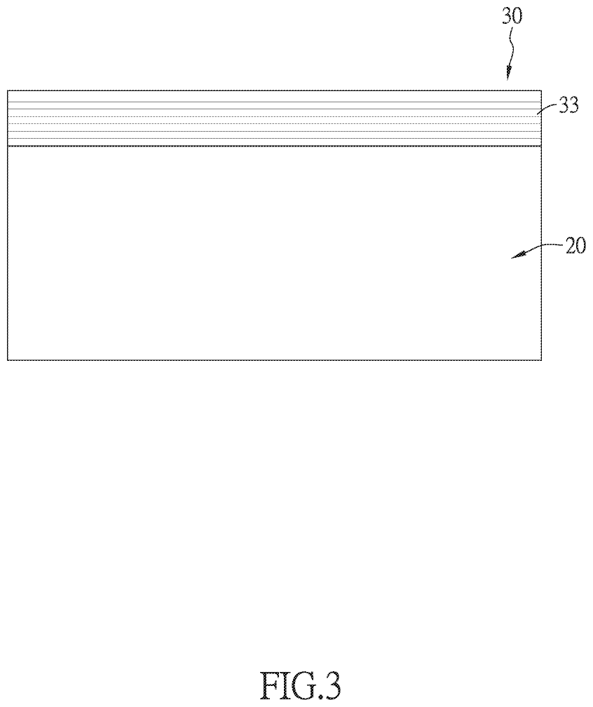

Referring to FIGS. 2-3, the present invention provides a seam structure of protective clothing that is capable of being formed quickly and has high sealing performance, and the seam structure of protective clothing comprises: a first cloth 10, a second cloth 20 and a sealing cloth 30.

The first cloth 10 includes a first side surface 11 and a second side surface 12 opposite to each other.

The second cloth 20 is welded to the first cloth 10 and includes a first surface 21 and a second surface 22 opposite to each other. The first surface 21 is abutted against and welded to the first side surface 11 to form a first welding portion S1.

The sealing cloth 30 includes a first sealing section 31 and a third sealing section 33, the first sealing section 31 is abutted against and welded to the second side surface 12 of the first cloth 10 to form a second welding portion S2, and the third sealing section 33 is abutted against and welded to the second surface 22 of the second cloth 20 to form a fourth welding portion S4.

Preferably, the sealing cloth 30 further includes a second sealing section 32 connected between the first sealing section 31 and the third sealing section 33. The first cloth 10 includes a first top surface 13, the second cloth 20 includes a second top surface 23, the second sealing section 32 is abutted against and welded to the first top surface 13 and the second top surface 23 to form a third welding portion S3.

In a specific embodiment, the first cloth 10, the second cloth 20 and the sealing cloth 30 are welded by ultrasonic vibration.

From the foregoing, it can be seen that the present invention mainly welds the first cloth 10, the second cloth 20 and the sealing cloth 30 to each other through technical means such as ultrasonic waves, so that the first welding portion Si is formed between the first cloth 10 and the second cloth 20, the second welding portion S2 is formed between the first sealing section 31 of the sealing cloth 30 and the second side surface 12, the fourth welding portion S4 is formed between the third sealing section 33 and the second surface 22, and the first welding portion S1, the second welding portion S2, and the fourth welding portion S4 are formed simultaneously, so as to achieve the purpose of rapid forming.

In addition, the sealing cloth 30 can close the gap between the first cloth 10 and the second cloth 20 to achieve the purpose of improving sealing performance.

Besides, in this invention, the first cloth 10, the second cloth 20 and the sealing cloth 30 are joined by welding technology. Therefore, there is no need to coat an additional layer of glue, which can avoid the problem of adhesion reduction after a long time.

While we have shown and described various embodiments in accordance with the present invention, it is clear to those skilled in the art that further embodiments may be made without departing from the scope of the present invention.

What is claimed is:

1. A seam structure of protective clothing that is capable of being formed quickly and has high sealing performance, comprising:
a first cloth including a first side surface and a second side surface opposite to each other;
a second cloth welded to the first cloth and including a first surface and a second surface opposite to each other, wherein the first surface is abutted against and welded to the first side surface to form a first welding portion;
a sealing cloth including a first sealing section and a third sealing section, wherein the first sealing section is abutted against and welded to the second side surface of the first cloth to form a second welding portion, and the third sealing section is abutted against and welded to the second surface of the second cloth to form a fourth welding portion.

2. The seam structure of protective clothing as claimed in claim 1, wherein the sealing cloth further includes a second sealing section connected between the first sealing section and the third sealing section, the first cloth includes a first top surface, the second cloth includes a second top surface, and the second sealing section is abutted against and welded to the first top surface and the second top surface to form a third welding portion.
